(19) United States
(12) Patent Application Publication
(10) Pub. No.: US 2025/0012301 A1
(43) Pub. Date: Jan. 9, 2025

(54) Protective Device for a Boiler Access Point

(71) Applicants: Explo Engineering AG, Niederlenz (CH); MARTIN GmbH für Umwelt-und Energietechnik, München (DE); Hitachi Zosen Inova AG, Zürich (CH)

(72) Inventors: Marc Peter Hangartner, Aarau (CH); Daniela Limacher-Lehner, Aarau Rohr (CH)

(21) Appl. No.: 18/706,397

(22) PCT Filed: Nov. 1, 2022
(86) PCT No.: PCT/EP2022/080465

§ 371 Date: May 1, 2024

(30) Foreign Application Priority Data
Nov. 2, 2021 (EP) 21206023.0

(51) Int. Cl. F15B 19/00

(52) U.S. Cl. CPC F15B 19/005; F15B 2211/6306

(57) ABSTRACT

Provided is a protective device for a boiler access point including a fan, a pressure sensor, and a check valve. The fan is connected via the access to the environment for drawing in ambient air and the pressure sensor is connected to it via a gas-tight connection and a check valve is connected downstream of the control unit via a further gas-tight connection. A control unit connected to the pressure sensor has a data memory in which at least a lower first and a higher second threshold value for pressure values are stored. The presence of a malfunction can be determined by the control unit when a pressure sensor signal measured by the pressure sensor and forwarded to the control unit is below the first or above the second threshold value.

### CROSS-REFERENCE TO RELATED APPLICATIONS

This application is the United States national phase of International Patent Application No. PCT/EP2022/080465 filed Nov. 1, 2022, and claims priority to European Patent Application No. 21206023.0 filed Nov. 2, 2021, the disclosures of which are hereby incorporated by reference in their entireties.

### BACKGROUND OF THE INVENTION

### Field of the Invention

The present invention relates to a protective device for a boiler access point via which an external device, such as a boiler cleaning device by introducing high-amplitude pressure waves, is connected to a boiler through a boiler wall.

### Description of Related Art

A device and method for generating high-amplitude pressure waves, in particular for boiler cleaning, is known from WO 2019/175736. The corresponding device has a discharge opening for the directed discharge of the gas pressure generated in a combustion chamber. This outlet opening generally ends in a hollow cylinder, which is fed through a boiler access point in the boiler wall into the boiler to be cleaned. For the purpose of cleaning, the said high-amplitude pressure wave is generated in the device when a boiler is in operation and introduced into the boiler volume.

The disadvantage here is that aggressive gases can flow from the boiler through the boiler access point in the boiler wall into the hollow cylinder and through this to the drain opening and thus to the piston valve seat. These gases can impair the tightness to such an extent that the rapid pressure build-up, which is advantageous for boiler cleaning, is impaired by a reduction in the quality of the valve seat.

DE 28 32 076 A1 discloses a protective device for a boiler access point with the features of the generic term of claim 1. A similar protective device is known from CN 212 004 409 U.

CN 210 950 060 U discloses a hydraulic ultra-high pressure safety valve with a check valve, whereby a pipe access opening is formed in the valve seat. A pressure relief cavity with a drain hole in the side wall of the cavity is formed in the upper part of the valve housing.

### SUMMARY OF THE INVENTION

Based on this prior art, the invention has the object of providing a protective device for a boiler access point which prevents such aggressive gases from flowing from the boiler through the boiler access point, in particular in a device for generating high-amplitude pressure waves with a hollow cylinder, to the drain opening and thus to the piston valve seat, and which can be monitored for correct functioning with a simple control unit.

The task is solved with a protective device for a boiler access point comprising a fan and a check valve, wherein the fan is connected via an access to the environment for drawing in ambient air and wherein the check valve is connected downstream of the fan via a gas-tight connection, which is then itself connected via a pressure hose to the boiler access point leading through a boiler wall, wherein the check valve is installed in such a way that it blocks at a fluid pressure present at the pressure hose if this is greater than the fluid pressure present at the fan, wherein an ambient outlet is provided in the gas-tight connection, characterized in that a control unit with a data memory is connected to the pressure sensor, in which at least a lower first and a higher second threshold value for pressure values are stored. The control unit receives the pressure sensor signals measured by the pressure sensor and compares them with the stored threshold values. If the pressure sensor signal is below the first threshold value, the presence of a malfunction is detected in a malfunction range.

If the pressure sensor signal measured by the pressure sensor and forwarded to the control unit is above the second threshold value, the presence of a malfunction in an overpressure range is detected. The malfunction in the overpressure range corresponds to a closure of the check valve or a blockage of the pressure hose. If the overpressure range is assigned by the control unit to a closure of the check valve, a time interval is advantageously stored in the control unit so that a malfunction signal is only emitted by the pressure sensor signal in the overpressure range if the specified time interval is exceeded. When the device described here is used in a device for boiler cleaning by introducing pressure waves through the boiler access point, a corresponding closure of the check valve over a time interval corresponding to the explosion shock can correspond to a regular operating function due to this pressure increase, so that there is no malfunction if this state ends after a correspondingly predetermined time interval and the check valve opens again.

The malfunction range in question can usually be divided into two different malfunction ranges, with a third threshold value for a pressure value that is lower than the first threshold value preferably being stored in the control unit. The control unit then divides the above-mentioned malfunction range into two sub-ranges in the case of a pressure sensor signal measured by the pressure sensor and forwarded to it. If the pressure value is below the third threshold value, the presence of a malfunction in the lower part of the malfunction range must be determined as a fan failure or sensor failure, while in the other case a leakage or filter problem must be assumed. In the drawing connecting the pressure measurement with the volume flow, only the fan failure is of course shown for the malfunction in the lower part of the malfunction range, as a sensor failure displays the same measured value, but this does not correlate with the actual volume flow in the air flow that continues to exist.

A pressure sensor located in this otherwise gas-tight connection can therefore be used to easily monitor the function of the fan and check valve.

Fans are all forms of fans such as axial fans and blowers that have an intake side and a discharge side on which the air from the intake side is discharged in compressed form.

This makes it possible, without access to an external gas supply, to simply protect a boiler access point from the ambient air before fluids from this access point come into contact with an external system to be protected, such as a boiler cleaning device.

The ambient outlet can, for example, be a hole in the wall of the gas-tight connection.

### BRIEF DESCRIPTION OF THE DRAWINGS

Preferred embodiments of the invention are described below with reference to the drawings, which are for explanatory purposes only and are not to be construed restrictively. The drawings show:

FIG. 1 shows a schematic block diagram of a device according to an embodiment of the invention;

FIG. 2 shows a fan characteristic curve for the operation of a device according to FIG. 1; and

FIG. 3 shows sensor value ranges of a control unit for the operation of a device according to FIG. 1.

### DESCRIPTION OF THE INVENTION

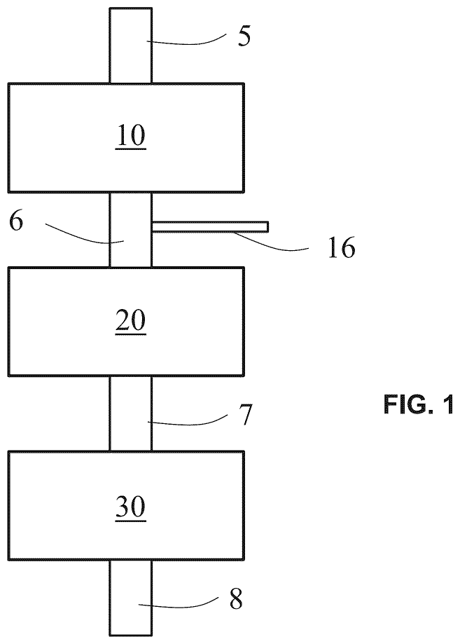

FIG. 1 shows a schematic block diagram of a device according to an embodiment of the invention. An intake pipe 5 is connected to a fan 10, which is installed in such a way that it compresses the ambient air drawn in from the intake pipe 5 of the boiler cleaning device and forwards it into the connection 6. The fan 10 can be a version with which an overpressure of 80-200 mbar can be built up in the continuing connection 6.

The continuing connection 6 is designed as a hollow cylindrical element, which has a minor influence on the air flow. An outlet 16 is provided at the side, with which the air flow generated by the fan 10 is divided.

One part is discharged back into the environment through the outlet 16 and the remaining part is channeled into a pressure sensor 20 via this connection 6.

In particular, the pressure sensor 20 can detect a pressure difference between 0 and 1 bar. The lower limit is essential and a value that cannot be reached by the fan 10 is advantageously selected as the upper limit.

Downstream of the pressure sensor 20, the pressurized ambient air is fed into the interior of the aforementioned hollow cylinder via a check valve 30 and a pressure hose 8 in the area between the valve seat of the aforementioned device and the boiler wall. In other words, the supply via, for example, a pressure hose 8 takes place outside the boiler access point, so that the pressurized ambient air flows through this access and the boiler wall towards the gases in the boiler.

The only requirement is that the fan 10 is powerful enough to blow the ambient air into the boiler in this way, whereby the overpressure generated by the fan 10 must be higher than the pressure prevailing in the boiler.

When cleaning explosions occur, the check valve 30 prevents reaction gases from the cleaning explosion in the drain opening in the boiler from entering the device in question here according to FIG. 1. Due to the sudden pressure build-up, a column of air will also remain in the supply line of the pressure hose 8 in front of the check valve 30.

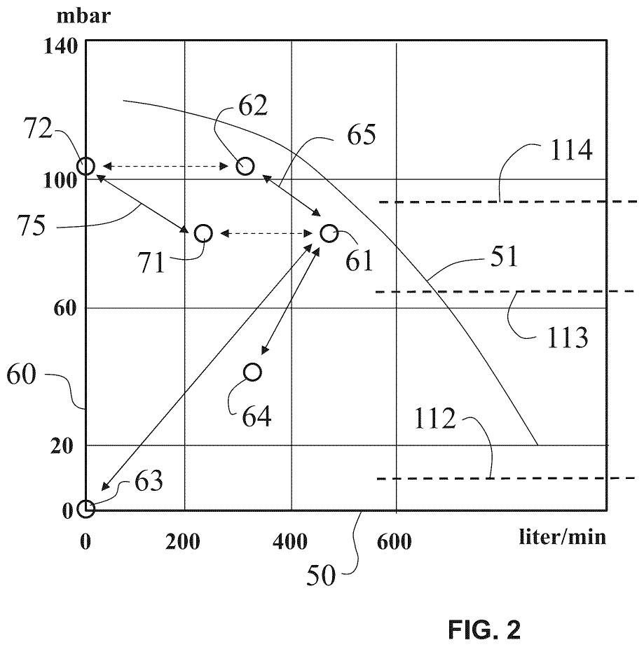

FIG. 2 shows a fan characteristic curve for the operation of a device according to FIG. 1, where the volume flow 50 is shown on the x-axis in volume per unit of time, here between 0 and 1,000 litres/minute (0 and 1 m³/min), while the overpressure 60 measured by the pressure sensor 20 is shown on the y-axis, here between 0 and 140 millibars. Both the volume flow 60 and the overpressure 50 are shown for one embodiment example. In other applications, a volumetric flow rate 60 of up to 10 or up to 100 m³/min can also be generated by using a fan 10 with a higher delivery rate. The overpressure at which this volume flow 60 is present relative to the boiler, i.e. at the boiler passage, depends on the geometry of the connections and the geometry of the orifice 16. This pressure can be up to 1 bar; as a rule, an overpressure of up to 200 or 500 millibars is sufficient.

The reference sign 51 shows the fan characteristic curve of the free-running fan 10, i.e. the overpressure generated with the corresponding volume of air conveyed per unit of time. The installation of the fan 10 in the device according to FIG. 1 results in different operating modes.

The reference sign 61 indicates the fan characteristic point at which the check valve 30 is open and thus permits a volume flow 60 of 470 litres per minute directly at the fan at the start of area 6, whereby an overpressure of approx. 80 millibars could be determined by a pressure sensor directly behind the fan 10. In the area upstream of the check valve 30, however, only a lower flow rate 60 of approx. 220 litres/minute is achieved, as a corresponding proportion of the rest escapes from the connection through the opening or orifice 16. Since the same air column is measured by the pressure sensor, the pressure is also approx. 80 millibars when the check valve 30 is open.

During operation of the cleaning device, pressure waves are triggered which find their way into the boiler and then also back into the pressure hose 8 on the way from the cleaning device to the boiler, causing the check valve 30 to close.

If the check valve 30 is now closed, this results in a higher pressure measured by the pressure sensor 20 and the characteristic curve point on the fan 62, which corresponds to a flow of 320 units per minute through the fan 10, as all the ambient air conveyed is now fed back outwards to the environment through the orifice 16. This leads to a pressure increase to approx. 110 millibars.

However, this corresponds directly at the now closed check valve 30 to a reduction of the volume flow from the approx. 220 litres/minute according to point 71 to a volume flow 72 of 0 litres/minute when the check valve 30 is closed.

In other words, the decrease in the volume flow actually present in the pressure hose 8 changes from the value at point 71 to point 72 corresponding to arrow 75. This is offset at the pressure sensor 20 by the decrease in the volume flow between points 61 and 62 corresponding to arrow 65, whereby the pressure increases from 80 millibars to just over 100 millibars. Here too, the actual pressure at the check valve 30 is equal to this measured pressure.

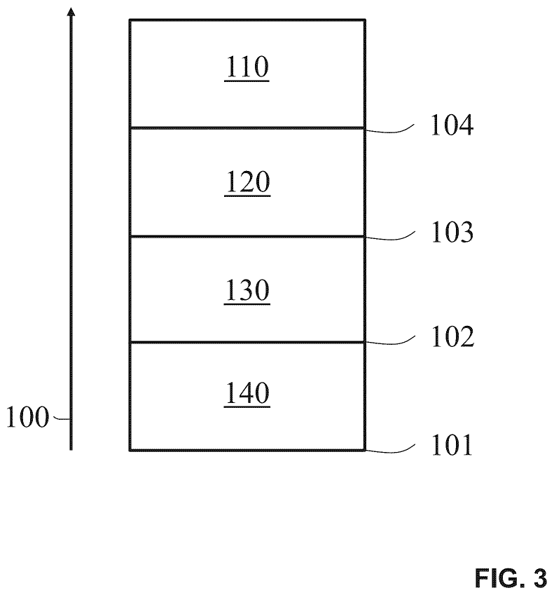

The orifice 16 as an ambient outlet can, for example, have a diameter of between 3 mm and 7.5 mm. However, the orifice 16 can also have a diameter of 1 mm to 2 cm, depending on the flow rate at which it is to be discharged and the pressure increase that is to build up upstream of the check valve 30 when it is closed. The choice of the diameter of the orifice and the type and length of the connection to the environment also depends on the desired overpressure and volume flow. When using a control unit, the basic arrangement of the measuring points as shown in FIG. 3 is essential for their evaluation, as described below.

In FIG. 2, three pressure threshold values 112, 113 and 114 of 10, 65 and 95 millibars are shown schematically and by way of example, which illustrate the pressure values that will be used accordingly in the explanation of the function of the control unit with the operating and malfunction ranges.

The device according to FIG. 1 advantageously has a control unit with which the fan 10 can be controlled in its performance and in which the sensor values of the pressure sensor 20 can be converted directly into monitoring values, so that this provides a direct indication of the function of the device as a result.

FIG. 3 shows sensor value ranges of a pressure sensor 20, which are analyzed in a control unit via threshold values for the operation of a device according to FIG. 1 for an indication or e.g. stop of the cleaning device or the boiler function. The sensor value ranges extend according to the arrow 100 from 0 to, for example, 1 bar. The inventors have established that the measured values of the pressure sensor 20 can be converted into direct monitoring values. At a pressure value 101 of 0 bar up to a pressure value 102 of, for example, 20 mbar as the first threshold value 112 shown in FIG. 2, it can be assumed that the pressure sensor or the fan has failed, so that the device has a self-diagnosis which indicates a malfunction range 140 accordingly.

Between the upper limit value 102 of the malfunction range 140 and the next larger limit value 103 of 90 mbar, for example, a filter problem may be present if such an optional filter is installed in the connections 6 or 7. This value range 130 characterizes either a filter problem or a leakage of the connections 6 or 7. The upper limit value 103 is shown as pressure threshold value 113 in FIG. 2. A distinction between the pressure threshold values 112 and 113 is useful for fault detection; the higher of the two threshold values is sufficient for monitoring the function.

At a pressure in the range between the value 103 and the pressure value 104, the operating range 120 is present, which corresponds to the normal value of the system. The working range is understood to be the operation of the boiler and not the rest periods of the boiler function when cleaning is due. If this upper limit value 104 is exceeded, an overpressure range 110 is reached, which corresponds to a blockage of the system, so that no gas flows through the connections 5, 6, 7 and 8 shown in FIG. 1, i.e. there is no protective function by the device, usually triggered by a response of the check valve 30. This can correspond to correct functioning of the device for a short time interval if an explosion shock is triggered in a boiler cleaning device of the type mentioned at the beginning, which of course may also enter the pressure hose 8 upstream of the boiler wall.

Thus, by a simple pressure measurement with a differential pressure sensor 20, the operating state of the ventilation system can be monitored by a selection of monitoring ranges 110, 120, and jointly or separately 130 and 140 via the above-mentioned threshold values 103, 104 and possibly 102.

By using ambient air as a supply, the supply of protective gases from corresponding pressurised gas containers for industrial gases can be largely dispensed with.

### LIST OF REFERENCE SIGNS

5 Intake pipe
6 Connection
7 Connection
8 Pressure hose
10 Fan
16 Outlet/orifice plate
20 Pressure sensor
30 Check valve
50 Volume flow
51 Fan characteristic free-running
60 Overpressure
61 Characteristic point on the fan/operating point open check valve
62 Characteristic point on the fan/operating point of closed check valve
63 Characteristic point on fan failure
64 Characteristic point for leakage or filter problem
65 Measured value change on the fan
71 Characteristic point on the check valve (open)
72 Characteristic point on the check valve (closed)
75 Change in measured value on the check valve
100 Pressure range (ascending values)
101 Pressure value 0 bar
102 Pressure value third threshold value
103 Pressure value first threshold value
104 Pressure value second threshold value
110 Overpressure range
112 Pressure level third threshold value
113 Pressure level first threshold value
114 Pressure level second threshold value
120 Working area
130 Failure range-filter problem or leakage
140 Failure range-sensor failure or fan failure

1. A protective device for a boiler access point in a boiler wall, comprising:
a fan;
a check valve;
a pressure sensor;
a gas-light connection having a pressure sensor and an ambient outlet;
a pressure hose; and
a control unit connected with the pressure sensor,
wherein the fan having an access is connected via the access to an environment for drawing in ambient air,
wherein the check valve is connected downstream of the fan via the gas-tight connection,
wherein the check valve is connected via the pressure hose to the boiler access point leading through the boiler wall,
wherein the check valve closes at a first fluid pressure present at the pressure hose if the first fluid pressure is greater than a second fluid pressure present at the fan, wherein the control unit comprises a data memory in which at least a lower first and a higher second threshold value for pressure values are stored,
wherein a presence of a malfunction in a malfunction range is detected by the control unit when a pressure sensor signal measured by the pressure sensor and forwarded to the control unit is below the first threshold value, and
wherein the presence of a malfunction in an overpressure range is detected by the control unit when the pressure sensor signal measured by the pressure sensor and forwarded to the control unit is above the second threshold value.

2. The protective device according to claim 1, wherein the overpressure range is assigned by the control unit to a closure of the check valve, a time interval being stored in the control unit, so that a malfunction signal is only emitted by the pressure sensor signal in the overpressure range if the predetermined time interval is exceeded.

3. The protective device according to claim 1, wherein a third threshold value for a pressure value, which is lower than the first threshold value, is stored in the control unit, and wherein the control unit indicates the presence of a malfunction in the malfunction area by distinguishing between leakage or sensor failure or fan failure in the case of a pressure sensor signal below the third threshold value measured by the pressure sensor and forwarded to the control unit.

4. The protective device according to claim 1, wherein the ambient outlet is a bore in the wall of the gas-tight connection.

5. (canceled)

6. The protective device according to claim 1, wherein the ambient outlet is arranged in the gas-tight connection between the fan and the pressure sensor.
